(19) United States
(12) Patent Application Publication
(10) Pub. No.: US 2016/0083974 A1
(43) Pub. Date: Mar. 24, 2016

(54) STRUCTURE FOR ASSEMBLING AND DISASSEMBLING PARTITION MEMBERS

(71) Applicant: L&P PROPERTY MANAGEMENT COMPANY, South Gate, CA (US)

(72) Inventors: JOSE MEZA, LYONS, IL (US); MATTHEW JOHNSON, CHICAGO, IL (US)

(21) Appl. No.: 14/493,016

(22) Filed: Sep. 22, 2014

(51) Int. Cl. E04H 17/16; E04H 17/14; E04H 17/20; F16M 13/02

(52) U.S. Cl. CPC E04H 17/168; F16M 13/02; E04H 17/14; E04H 17/165; E04H 17/20; E04H 2017/1486; E04H 2017/1491

(57) ABSTRACT

Embodiments of the invention provide a device, mechanism and system for assembling and disassembling partition members. In some aspects a partition assembly system includes at least one vertical support post; and at least one locking bracket configured to couple to the at least one vertical support post, wherein the at least one locking bracket comprises: (1) a first c-shaped bracket structure having a first curved slot and a first angled slot; and (2) a second c-shaped bracket structure coupled to the first c-shaped bracket structure, said second c-shaped bracket structure having a second curved slot and a second angled slot, wherein the second c-shaped bracket structure is coupled to the first c-shaped bracket structure such that the first angled slot is adjacent the second curved slot and the first curved slot is adjacent the second angled slot.

### CROSS-REFERENCE TO RELATED APPLICATIONS

Not Applicable.

### TECHNICAL FIELD

The present invention generally relates to a partition assembly structure. More particularly, the invention relates to a partition assembly system including interchangeable locking brackets configured to secure a series of partition panels to vertical support posts.

### BACKGROUND OF THE INVENTION

It may be useful to separate an inner protected area from a more accessible area using a series of partition members that form an enclosure. The enclosure may be assembled from a series of vertical supports that secure adjacent partition panels. Such an enclosure system may require multiple tools for assembly, multiple users for manipulation, and may include excess nuts and bolts for attachment. A need exists for a reliable partition assembly system that enables a single user to quickly and easily attach individual partition panels to a series of stabilizing support posts, for use in a variety of enclosure type applications.

### BRIEF SUMMARY OF THE INVENTION

The present invention generally relates to a partition assembly system including interchangeable locking brackets configured to secure a series of partition panels to vertical support posts. In one embodiment, a device for assembling and disassembling partition members includes: at least one locking bracket configured to couple to at least one vertical support post, wherein the at least one locking bracket comprises: (1) a first c-shaped bracket structure having a first curved slot and a first angled slot; and (2) a second c-shaped bracket structure coupled to the first c-shaped bracket structure, said second c-shaped bracket structure having a second curved slot and a second angled slot, wherein the second c-shaped bracket structure is coupled to the first c-shaped bracket structure such that the first angled slot is adjacent the second curved slot and the first curved slot is adjacent the second angled slot.

In another illustrative aspect, the present invention includes a partition assembling system comprising: at least two vertical support posts; at least two locking brackets coupled to a first vertical support post of the at least two vertical support posts; at least two locking brackets coupled to a second vertical support post of the at least two vertical support posts; and at least one partition panel comprising at least four attachment mechanisms, wherein the at least one partition panel is configured to couple to the at least two vertical support posts based on: (1) coupling two of the at least four attachment mechanisms to the first vertical support post using the at least two locking brackets coupled to the first vertical support post, and (2) coupling two of the at least four attachment mechanisms to the second vertical support post using the at least two locking brackets coupled to the second vertical support post.

In another embodiment, a partition assembly mechanism includes: a partition assembly mechanism comprising: a pair of first locking brackets coupled to a pair of vertical support posts; a pair of second locking brackets coupled to the pair of vertical support posts; and a partition panel comprising a pair of upper stud pins on opposite vertical sides of an upper portion of the partition panel, and a pair of lower stud pins on opposite vertical sides of a lower portion of the partition panel, wherein each of the locking brackets comprises: (1) a first c-shaped bracket structure comprising a first angled slot and a first curved slot, and (2) a second c-shaped bracket structure comprising a second angled slot and a second curved slot.

Additional objects, advantages, and novel features of the invention will be set forth in part in the description which follows, and in part will become apparent to those skilled in the art upon examination of the following, or may be learned by practice of the invention.

### BRIEF DESCRIPTION OF SEVERAL VIEWS OF THE DRAWINGS

The present invention is described in detail below with reference to the attached drawing figures, wherein:

FIG. 1 is a front perspective view of a vertical support post and interchangeable locking brackets of a partition assembly system, in accordance with embodiments of the invention;

FIG. 2 is a front perspective view of the partition assembly system of FIG. 1, in accordance with embodiments of the invention;

FIG. 3 is a front perspective view of a partition panel of a partition assembly system, in accordance with embodiments of the invention;

FIG. 4 is a front perspective view of a partition assembly system in a partially detached configuration, in accordance with embodiments of the invention;

FIG. 5 is a front perspective view of a partition assembly system in a partially detached configuration, in accordance with embodiments of the invention;

FIG. 6 is a front view of the partition assembly system of FIG. 5, in accordance with embodiments of the invention;

FIG. 7 is a front perspective view of a partition assembly system in an attached configuration, in accordance with embodiments of the invention;

FIG. 8 is a front view of the partition assembly system of FIG. 7, in accordance with embodiments of the invention;

FIG. 9 is a perspective view of a stud pin and an attachment feature for coupling a component of the partition assembly system, in accordance with embodiments of the invention;

FIG. 10 is a top perspective view of an interchangeable locking bracket, in accordance with embodiments of the invention;

FIG. 11 is a top perspective view of an interchangeable locking bracket securing stud pins, in accordance with embodiments of the invention;

FIG. 12A is a top view of a first c-shaped bracket portion, in accordance with embodiments of the invention;

FIG. 12B is a top view of a coupled first c-shaped bracket portion and a second c-shaped bracket portion, in accordance with embodiments;

FIG. 13 is a plan view of the first c-shaped bracket, in accordance with embodiments of the invention; and

FIG. 14 is a perspective view of a partition assembly system including a series of interconnected partition panels and vertical support posts, in accordance with embodiments of the invention.

### DETAILED DESCRIPTION OF THE INVENTION

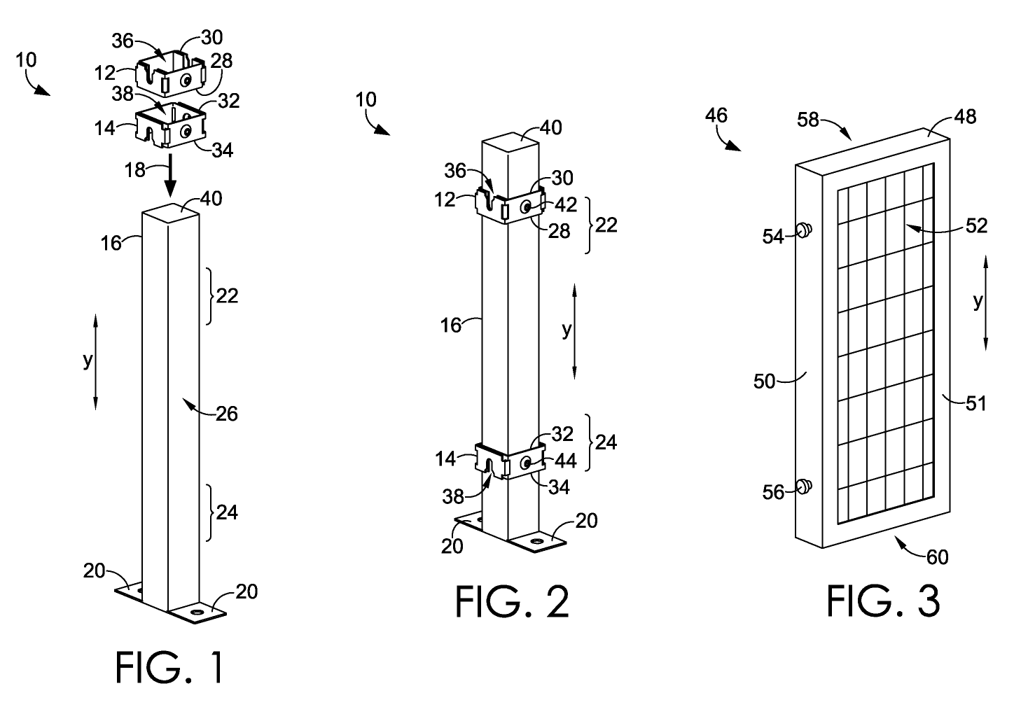

Referring initially to FIG. 1, a front perspective view of a partition assembly system 10 for use in a variety of applications is provided. In some embodiments, partition assembly system 10 includes a first locking bracket 12, a second locking bracket 14, and a vertical support post 16. In one embodiment, interchangeable first and second locking brackets 12 and 14 are formed from a steel material, but can be formed from other materials in further embodiments. Similarly, embodiments of the vertical support post 16 are metal. The partition assembly system 10 shown in the figures is one possible configuration, but it should be understood that other configurations, shapes, materials, etc., could be implemented depending on the particular partition assembly application. Moreover, the inventive concepts disclosed herein could be applied to many other applications, such as storage lockers, bins, etc.

In the exemplary embodiment of FIG. 1, the first and second locking brackets 12 and 14 are coupled to the body 40 of the vertical support post 16 by moving in a downward direction 18. In some embodiments, the vertical support post 16 includes a post attachment plate 20, an upper bracket attachment portion 22, a lower bracket attachment portion 24, and a bracket attachment surface 26 on the vertical support post 16. The solid edge 28 of the first locking bracket 12 and the coupling edge 34 of the second locking bracket 14 are oriented on leading edges of the respective locking brackets in the downward direction 18 toward the vertical support post 16. As such, the coupling edge 30 of the first locking bracket 12 and the solid edge 32 of the second locking bracket 14 are oriented on a following edge in an opposite direction. In further embodiments, the bracket cavity 36 of the first locking bracket 12 and the bracket cavity 38 of the second locking bracket 14 are configured to couple to the body 40 of the vertical support post 16 along the y-axis.

With reference to the embodiment of FIG. 2, the partition assembly system 10 includes the first locking bracket 12 and the second locking bracket 14 coupled to the vertical support post 16. In one embodiment, a set screw 42 couples the first locking bracket 12 to the upper bracket attachment portion 22, while the set screw 44 couples the second locking bracket 14 to the lower bracket attachment portion 24. The exemplary set screws 42 and 44 may be any mechanism for coupling the first locking bracket 12 and the second locking bracket 14 to at least a portion of the vertical support post 16. As shown in the example of FIG. 2, the set screw 42 may be coupled to one of a number of locations along the upper bracket attachment portion 22, while the set screw 44 may be coupled to one of a number of locations along the lower bracket attachment portion 24. In some aspects, the placement of a first locking bracket 12 and a second locking bracket 14 within the respective upper and lower bracket portions 22 and 24 for a secured partition assembly 10 may vary based on a position of corresponding coupling mechanisms on a side portion of a partition panel, as discussed further below. As such, in some embodiments of the invention, an upper bracket attachment portion 22 may include a larger or a smaller amount of the bracket attachment surface 26, while the lower bracket attachment portion 24 may include a larger or a smaller amount of the bracket attachment surface 26. For example, the upper and lower bracket attachment portions 22 and 24 may define a general region where the first and second locking brackets 12 and 14 may be coupled to the vertical support posts 16 in order to alight with and/or couple to the corresponding upper and lower stud pins 54 and 56.

The exemplary embodiment of FIG. 3 includes a front perspective view 46 of an exemplary partition panel 48 oriented along a y-axis of a partition assembly system 10. In one embodiment of the invention, the partition panel 48 includes a pair of opposing side portions 50 and 51, a wire grid 52, an upper stud pin 54 and a lower stud pin 56 on the side portions 50 and 51, a partition panel top 58, and a partition panel bottom 60. The upper stud pin 54 may be configured to couple to a first locking bracket 12 positioned within the upper bracket attachment portion 22, while the lower stud pin 56 may be configured to couple to a second locking bracket 14 positioned within the lower bracket attachment portion 24, according to some embodiments. For example, the upper stud pins 54 may first be coupled to the first locking bracket 12; with the first locking bracket 12 secured in a stationary first position within the upper bracket attachment portion 22 using upper set screws 42 (i.e., stabilizing the partition panel top 58 with respect to the vertical support posts 16). Further, upon positioning the partition panel bottom 60 in alignment with the vertical support posts 16, the lower stud pins 56 may be spaced apart from, adjacent to, and/or in contact with the second locking brackets 14, with the second locking brackets moveably coupled to the vertical support posts 16 (i.e., slid onto the body 40 of the vertical support posts 16 but not yet in a stationary and/or secured position within the lower bracket attachment portion 24). Finally, the user may secure the second locking brackets 14 to a particular position within the lower bracket attachment portion 24; for example, by securing the second locking brackets 14 with the set screws 44 to ensure that at least a portion of the second locking brackets 14 engages the lower stud pins 56. In one example, the second locking brackets 14 may be shifted from a first, moveable position with respect to the lower stud pins 56, to a second stationary position with respect to the lower stud pins 56, thereby restricting movement of the partition panel 48 with respect to the vertical support posts 16.

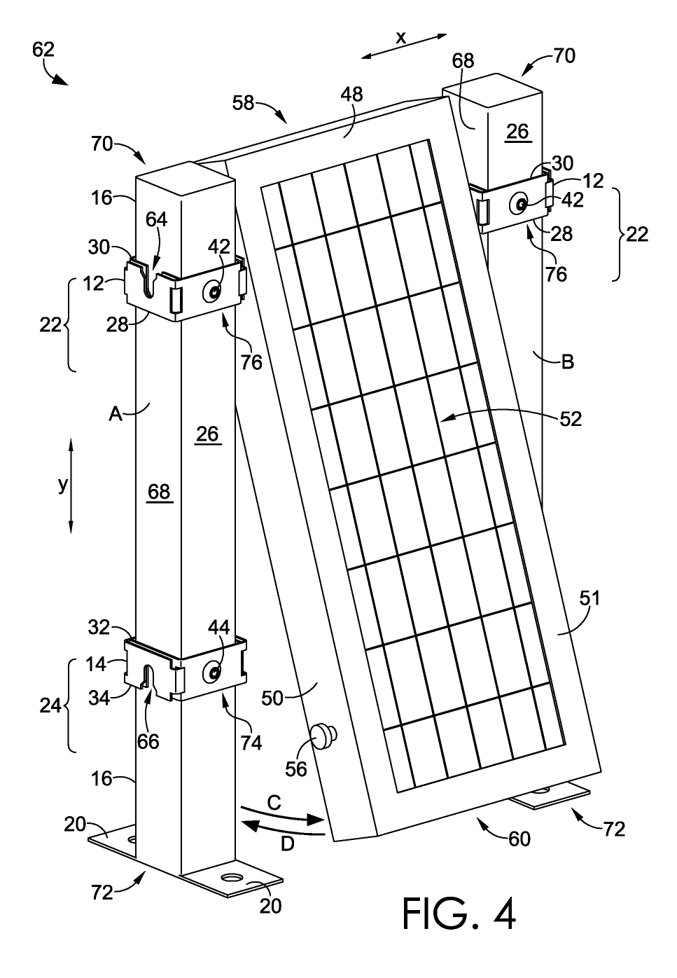

With reference to FIG. 4, a front perspective view of a partition assembly system 62 in a partially detached configuration is depicted according to embodiments of the invention. As shown in the embodiment of FIG. 4, the opposing side portions 50 and 51 of exemplary partition panel 48 are coupled to vertical support posts A and B. In one embodiment, at least one surface of the vertical support posts A and B includes an attachment surface for coupling the vertical support posts 16 to one or more partition panels 48 via a slot feature on each of the the locking brackets. For example, in one embodiment, each of the vertical support posts A and B include a panel attachment surface 68 that supports the bracket slot 64 of the first locking bracket 12 and the bracket slot 66 of the second locking bracket 14 coupled to the vertical support post 16.

According to another aspect, based on the orientation of each of the vertical support posts 16 in an upright position along the y-axis, with the post upper end 70 opposite the post lower end 72, the panel top 58 of the partition panel 48 may be coupled to the first locking brackets 12 coupled to the upper bracket attachment portions 22 of each of the vertical support posts 16. The coupling of the partition panel 48 to the upper bracket attachment portions 22 may be a pivoting and/or rotational coupling along the x-axis such that the panel bottom 60 is moveable in an outward direction C. Accordingly, the second locking brackets 14 (i.e., one on each of the two vertical support posts 16) may be shifted into an upright position with respect to the lower bracket attachment portion 24. As such, the stud pins 56 on opposing side portions 50 and 51 of the partition panel 48 may be configured to remain uncoupled from the vertical support posts 16 based on the bracket slots 66 on the panel attachment surface 68 remaining out of alignment with the stud pins 56 on opposing side portions 50 and 51. In some aspects, second locking bracket 14 is temporarily configured in a moveable first position 74 with respect to the lower bracket attachment portion 24, while the first locking bracket 12 is configured in a stationary first position 76 with respect to the upper bracket attachment portion 22.

As shown in the example of FIG. 4, each of the vertical support posts 16 may be configured with at least one panel attachment surface 68 and at least one bracket attachment surface 26. In further aspects, embodiments of the vertical support posts 16 may include at least two panel attachment surfaces 68 on opposing sides of the vertical support posts 16 and/or at least one bracket attachment surface 26. As such, a vertical support post 16 may be configured to support and/or couple to a locking bracket 12 (in an upright position with the coupling edge 30 facing upward relative to the vertical y-axis of the partition assembling system 62) on an upper bracket attachment portion 22 of a panel attachment surface 68, while also supporting and/or coupling to a locking bracket 14 (in a downward-facing position with the coupling edge 34 facing downward relative to the vertical y-axis of the partition assembling system 62). In some aspects, while the bracket slots 66 of the locking bracket 14 are disengaged from the stud pins 56 (i.e., while the locking bracket 14 is in a first position 74 that is not in alignment with and/or engaged with the stud pins 56 on opposing side portions 50 and 51), the panel bottom 60 may move freely while the panel top 58 rotates about the stud pins 54 coupled to the bracket slots 64 of the first locking brackets 12.

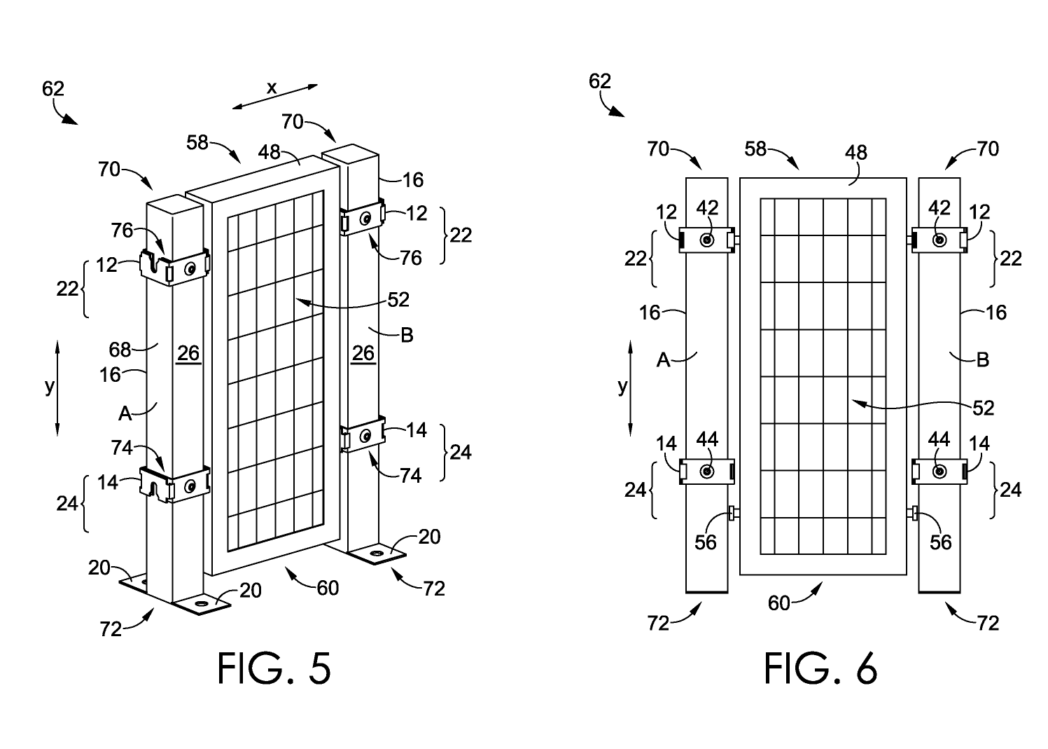

As shown in the exemplary embodiment of FIG. 5, a front perspective view of a partition assembly system 62 in a partially detached configuration includes a pair of second locking brackets 14 in a first position 74. As further depicted in FIG. 6, with the pair of second locking brackets 14 in a first position 74, the bracket slots 66 (facing in a downward direction) are not aligned with the stud pins 56 of the partition panel 48. In other words, based on the position of each of the second locking brackets 14, the stud pins 56 on the panel bottom 60 are disengaged from both of the bracket slots 66 on each of the second locking brackets 14. In further embodiments, the pivoting coupling of the stud pins 54 on the panel top 58 end of the partition panel 48 are engaged with and/or coupled to the first locking brackets 12 in a first step of assembly by a single user. As shown in the examples of FIGS. 4 and 5, a panel bottom partition panel 48 may be rotated in a first direction C away from the vertical support posts 16 while the stud pins 56 are disengaged from the second locking brackets 14, and may be rotated in a second direction D towards the vertical support posts 16 to align the partition panel 48 with the vertical support posts 16 and align the stud pins 56 for securing by the second locking brackets 14.

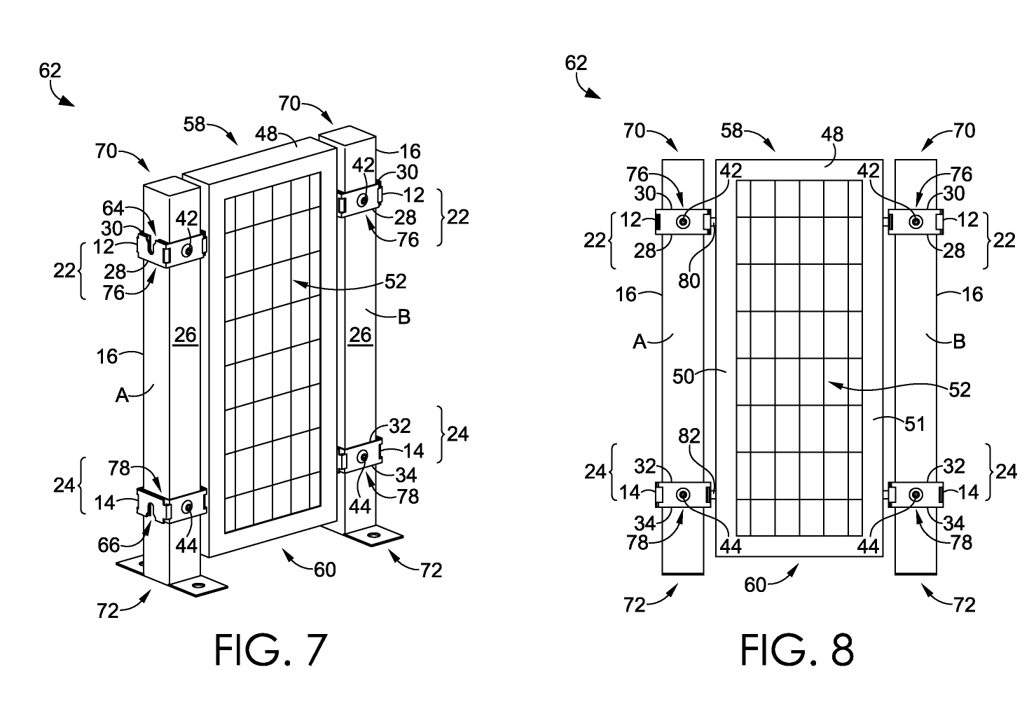

In further aspects, the single user may then change the position of the second locking brackets 14 into a second position 78, as shown in FIG. 7, to engage the pair of stud pins 56 on the panel bottom 60 with the bracket slots 66 on the interior panel attachment surface 68 on a pair of vertical support posts 16. With contrast to the disengaged first position 74 of the pair of second locking brackets 14 in FIGS. 5-6, the second position 78 of the second locking brackets 14 in FIGS. 7-8 enables both the upper coupling 80 (between the first locking brackets 12 and the pair of bracket slots 64) and the lower coupling 82 (between the second locking brackets 14 and the pair of bracket slots 66) to secure the partition panel 48 in a stationary position. In some aspects of the invention, the single user may attach and/or couple the upper stud pins 54 to the first locking brackets 12 in a first step with the panel bottom 60 rotated in a direction C away from the vertical support posts 16, rotate the panel bottom 60 towards the vertical support posts 16 in a second step to align the body of the partition panel 48 with the vertical axis y, and reposition the second locking brackets 14 from the first position 74 to the second position 78 and engage the bracket slots 66 with the stud pins 56 in a third step.

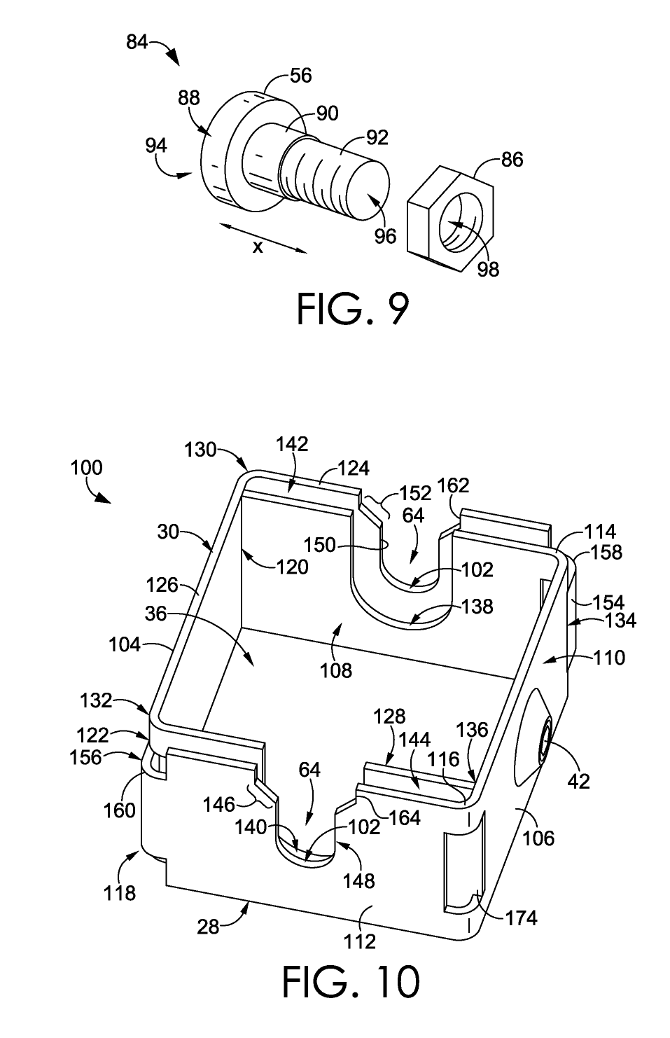

Turning now to FIGS. 9-13, various components and/or features of an exemplary partition assembly system 62 are provided. In the perspective view of FIG. 9, an exemplary attachment mechanism 84 includes a stud pin 56 and an attachment feature 86 (e.g., a washer, nut, clamp, or other feature for securing at least one end of the stud pin 56) for coupling a component of the partition assembly system 62 is provided. In the example of FIG. 9, the stud pin 56 includes a stud pin head 88 adjacent a stud pin middle 90, which is adjacent to a stud pin bottom 92. The stud pin 56 is oriented along a central longitudinal axis x, having an upper end 94 and a lower end 96. In some embodiments, a portion of the upper end 94, such as the stud pin head 88, is coupled with a bracket slot of a locking bracket, such as a bracket slot 64 or a bracket slot 66 of a first locking bracket 12 and/or second locking bracket 14. As further depicted in the exemplary attachment mechanism 84, the attachment feature 86 includes an opening 98 configured to secure at least a portion of the lower end 96 of the stud pin 56.

In the exemplary embodiment of FIG. 10, a top perspective view of an interchangeable locking bracket 100 includes curved portions on opposite sides of the locking bracket 100, which form the bracket slots 64 on an upward-facing locking bracket (and/or the bracket slots 66 on a downward-facing locking bracket). As will be understood, in some embodiments of the invention, the locking bracket 100 may be referred to as an “interchangeable” locking bracket 100 by virtue of the common configuration of the locking bracket structure that can be positioned in one direction to provide an upper and/or first locking bracket 12 (i.e., facing upward to provide a bracket slot 64 on the curved portions), and positioned in another direction to provide a lower and/or second locking bracket 14 (i.e., facing downward to provide a bracket slot 66 on the curved portions).

With continued reference to FIG. 10, the locking bracket 100 includes a first c-shaped bracket structure 104 coupled to a second c-shaped bracket structure 106. In the embodiment of FIG. 10, the second c-shaped bracket structure 106 includes a first portion 108, a second portion 110, a third portion 112, a first corner 114, a second corner 116, a first end 120, and a second end 122. Additionally, the first c-shaped bracket structure 104 includes a first portion 124, a second portion 126, a third portion 128, a first corner 130, a second corner 132, a first end 136, and a second end 134. As shown in the example of FIG. 10, the locking bracket 100 may be configured with an internal cavity 36 formed between the coupled first c-shaped structure 104 and the second c-shaped structure 106. The internal cavity 36 may be configured to couple to an outer surface of the body 40 of a vertical support post 16, such as a square-shaped internal cavity 36 configured to couple to and/or slide onto the outer surface of the vertical support post 16.

Each of the first c-shaped bracket structure 104 and the second c-shaped bracket structure 106 includes at least two features that combine to provide the curved portions of the locking bracket 100, according to embodiments of the invention. In some aspects, the first c-shaped bracket structure 104 includes a first angled slot 150 and a first curved slot 140, while the second c-shaped bracket structure 106 includes a second angled slot 148 and a second curved slot 138. As shown in the embodiment of FIG. 10, the first angled slot 150 of the first c-shaped bracket structure 104 is aligned with and/or parallel to the second curved slot 138 of the second c-shaped bracket structure 106. As such, the second angled slot 148 is aligned with and/or parallel to the first curved slot 140. Based on the first corner 130 and the second corner 132 of the first c-shaped bracket structure 104, the first portion 124 and the third portion 128 are aligned in a parallel configuration, with both portions perpendicular to the second portion 126. Similarly, the second c-shaped bracket structure 106 includes the first corner 114 and second corner 116, which align the first portion 108 parallel to the third portion 112, with both the first and third portions 108 and 112 perpendicular to the second portion 110. In some embodiments, based on the corresponding corners and portions described above, each of the two portions of the locking bracket 11 are c-shaped in structure, and when mated together, form an internal cavity 36 (and/or cavity 38) for securing to the body 40 of the vertical support post 16.

With continued reference to the exemplary embodiment of FIG. 10, in some embodiments of the invention, at least one portion of the locking bracket 100 includes an open portion 118 provided by one or more portions of the first c-shaped bracket structure 104 and the second c-shaped bracket structure 106 separated a threshold distance. Embodiments of the locking bracket 100 include a threshold distance 142 between the first portion 124 of the first c-shaped bracket structure 104 and the first portion 108 of the second c-shaped bracket structure 106. In some aspects, the threshold distance 142 is determined based on the length of the second portion 126 and the second portion 110, and based on the location of the first corner 130, first corner 114, second corner 132, and second corner 116. In other words, an amount of separation between the first portion 124 and first portion 108, as well as the amount of separation between the third portion 128 and the third portion 112, provides a cavity and/or threshold distance 142 and 144 for securing the stud pin head 88 of a stud pin coupled to a side of a partition panel 48.

The angled slots of each of the c-shaped bracket structures may include one or more edge features that coordinate with the curved edge of the curved slots in some embodiments of the invention. In further embodiments, the angled slots may include various edge features that differ from the edges of a corresponding curved slot based on one or more straight and/or angled surfaces and/or features. In the example of FIG. 10, the first angled slot 150 on the first c-shaped bracket structure 104 includes a curved portion 102, an angled portion 152, and a vertical portion 162. Further, exemplary second angled slot 148 includes a curved portion 102, an angled portion 146, and a straight portion 164. In some aspects, the curved portions 102 on both the first c-shaped bracket structure 104 and the second c-shaped bracket structure 106 are configured to couple interchangeably to a stud pin (i.e., the stud pin head 88). In other words, a similarly shaped stud pin 54 or 56 may be coupled to either angled slot when coupled to a first panel attachment surface 68 on a first vertical support post, and a second panel attachment surface on the second vertical support post. As such, a single locking bracket may be used to couple partition panels on both sides of the vertical support post to provide a partition assembly system 62.

In some aspects of the invention, for coupling the first c-shaped and second c-shaped bracket structures 104 and 106, each includes a fourth portion, such as the fourth portion 154 and fourth portion 156. Each of the fourth portions is provided based on an additional curve and/or corner, such as the third corner 158 and the third corner 160. By providing the fourth portions 154 and 156, the second end 134 is coupled to the second portion 110 to provide the threshold distance 142 based on the width of the fourth portion 154. Similarly, the second end 122 is coupled to the second portion 126 to provide a threshold distance 144 based on the width of the fourth portion 156, in some embodiments of the invention.

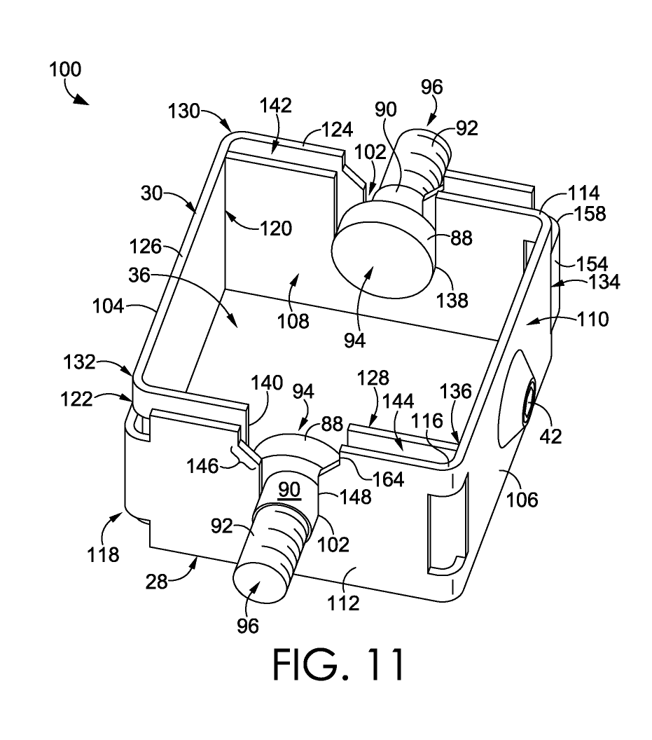

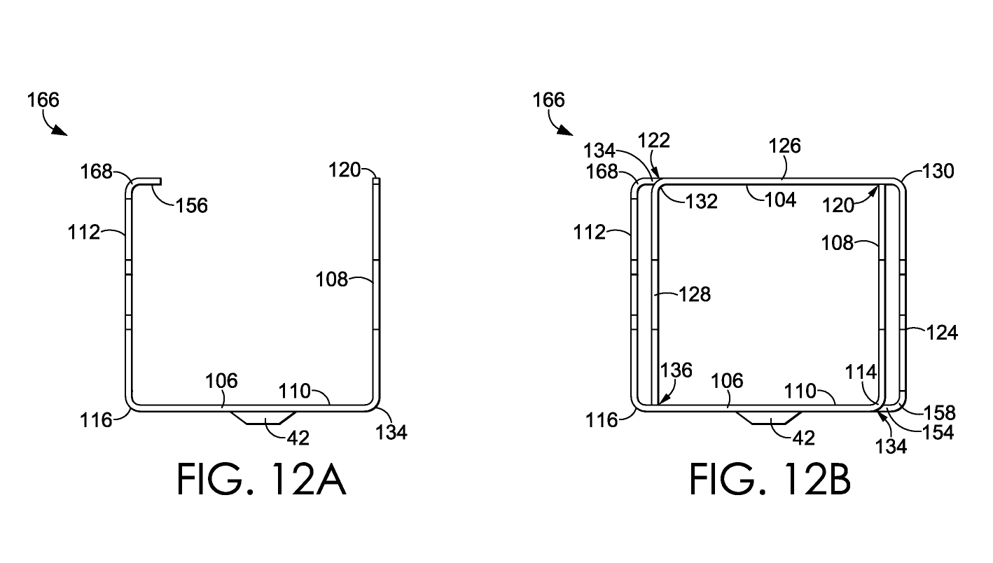

Referring finally to FIG. 11, a top perspective view of an interchangeable locking bracket 100 securing stud pins is provided. In the example of FIG. 11, stud pins are coupled to the upward-facing bracket slots 64. In an inverted position, the same locking bracket 100 may secure stud pins in the downward-facing bracket slots 66. As such, a first bracket 12 facing upward may support the upper stud pins 54 of a partition panel 48, while a second bracket 14 facing downward may support the lower stud pins 56 of a partition panel 48. As shown in the example of FIG. 11, the stud pin middle 90 is shown coupled to the curved portion 102 and at least partially positioned within the cavities of the threshold distance 142 and 144. Additionally, the stud pin head 88 is secured at least in part within the inner cavities of the threshold distances 142 and 144, as well as within the inner bracket cavity 36 based on positioning of the stud pin head 88 within the first curved slot 140 and the second curved slot 138. In FIGS. 12A and 12B, an embodiment of a top plan view 166 of the upper edge 168 includes the layout of each of the features described with respect to FIGS. 10-11.

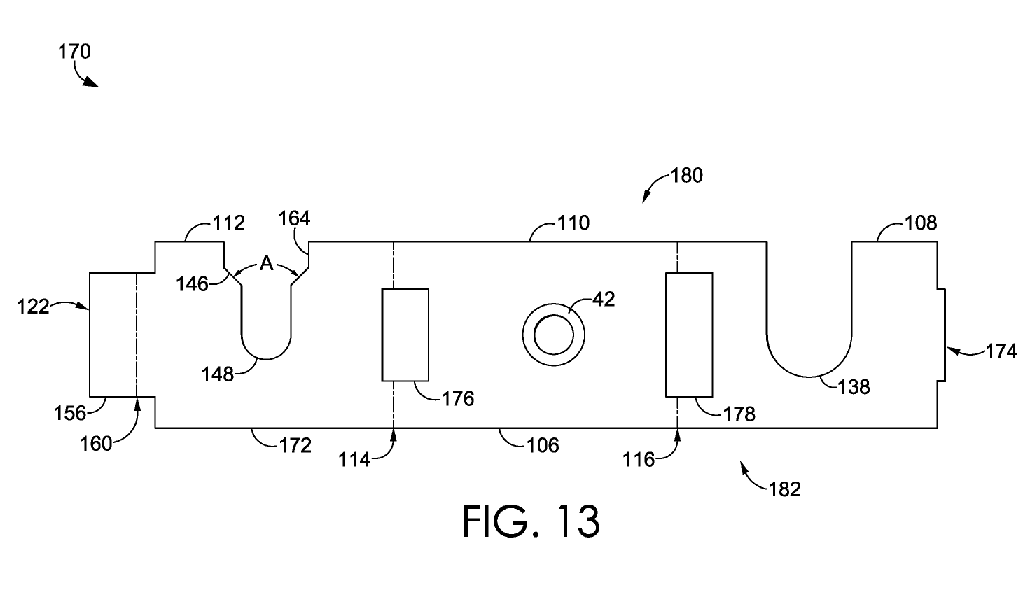

With reference to the plan view 170 in FIG. 13, the template body 172 of an exemplary c-shaped bracket structure includes a fifth portion 174, a first opening 176, a second opening 178, an upper end 180, and a lower end 182 on an exemplary second c-shaped bracket 106. In the example of FIG. 13, a coupling portion is included on the second portion 110, such as the set screw 42. As will be understood, for an opposing template body coupled to the template body 172 of FIG. 13, such as a first c-shaped bracket 104, the template body may include a similar structure without the set screw and/or coupling feature on a second portion 126. In other words, in some embodiments of the invention, a locking bracket may be coupled to a vertical support post using a set screw on one side of one of the c-shaped bracket structures, which supports the adjacent (set-screw-less) c-shaped bracket structure coupled to it.

In some aspects of the invention, a pair of c-shaped bracket structures may be coupled together based on at least a portion of the fifth portion 174 on a first c-shaped bracket structure coupled to an opening 176 of an adjacent, second c-shaped bracket structure. Further, the fourth portion 156 of the first c-shaped bracket structure may be coupled to an opening 178 of an adjacent, second c-shaped bracket structure. In further aspects, the fifth portion 174 of the second c-shaped bracket structure may be coupled to an opening 176 of the first c-shaped bracket structure, while the fourth portion 154 of the second c-shaped bracket structure may be coupled to an opening 178 of the first c-shaped bracket structure.

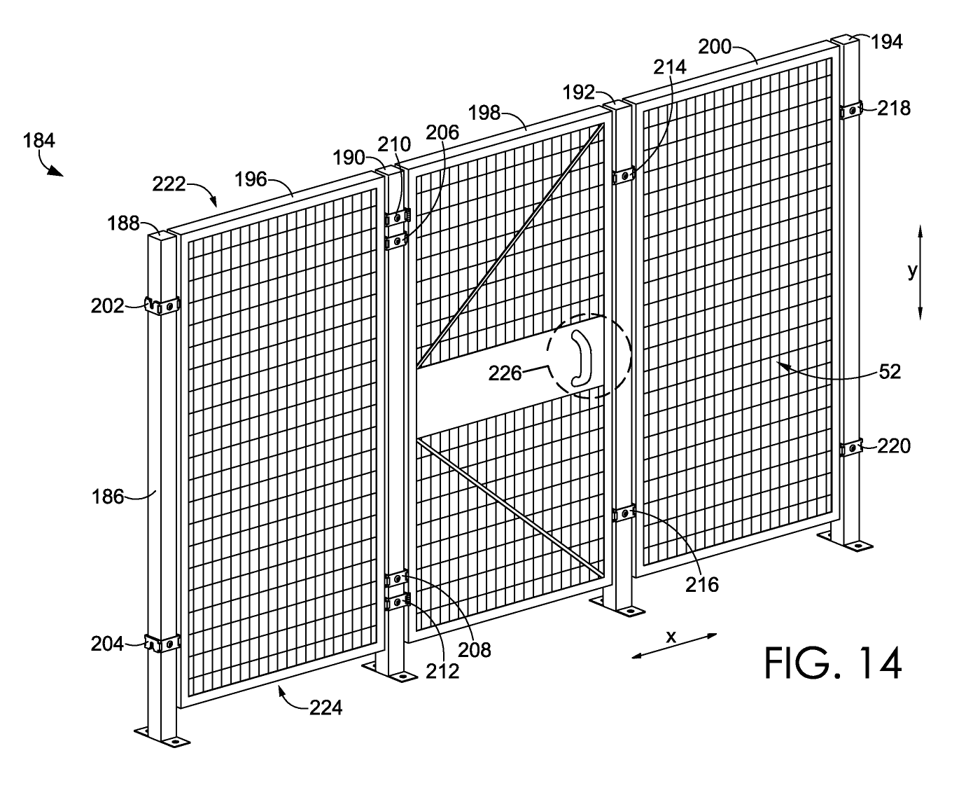

Referring finally to FIG. 14, an exemplary assembled partition 184 includes a multiple-panel structure 186 assembled from multiple vertical support posts coupled to multiple partition panels. In one example, at least a portion of an assembled partition 184 includes a first vertical support 188, a second vertical support post 190, a third vertical support post 192, a fourth vertical support post 194, a first panel 196, a second panel 198, a third panel 200, a first locking bracket 202, a second locking bracket 204, a third locking bracket 206, a fourth locking bracket 208, a first hinged bracket 210, a second hinged bracket 212, a fifth locking bracket 214, a sixth locking bracket 216, a seventh locking bracket 218, and an eighth locking bracket 220. In some embodiments of the invention, the partition panels are oriented along the y-axis, such that the upper edge 222 and lower edge 224 of each partition panel is aligned along an x-axis of the exemplary assembled partition 184. In some aspects, a handle area 226 may be included in a partition assembly system, providing an entrance portion to the assembled partition 184.

During assembly of the partition 184, each of the stud pins on the sides of the partition panels may be coupled to each of the corresponding locking brackets without assistance from any additional tools and/or mechanism for engaging the coupling features of each component. In one example, a user may manipulate the upper set screws of the upper locking brackets into an upper, stationary position. Without use of an additional tool or assembly mechanism, the user may then position the upper stud pins on the upper end of the partition panel by lowering the stud pins into and/or positioning the stud pins within the corresponding curved slots (e.g., within at least a portion of the threshold distance between the adjacent side portions of the c-shaped bracket structures and/or within at least a portion of the internal cavity of the locking bracket itself). Upon rotating the lower end of the partition panel into place, and adjusting the position of the moveable lower locking mechanisms, the stud pins on the lower end of the partition panel may then be coupled to the corresponding lower locking brackets without any additional tools (i.e., without any tools other than those required to secure the set screws of each of the moveable lower locking brackets).

From the foregoing, it will be seen that this invention is one well adapted to attain all the ends and objects hereinabove set forth together with other advantages, which are obvious and which are inherent to the structure.

It will be understood that certain features and subcombinations are of utility and may be employed without reference to other features and subcombinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

1. A device for assembling and disassembling partition members, the device comprising:
at least one locking bracket configured to couple to at least one vertical support post, wherein the at least one locking bracket comprises:
(1) a first c-shaped bracket structure having a first curved slot and a first angled slot; and
(2) a second c-shaped bracket structure coupled to the first c-shaped bracket structure, said second c-shaped bracket structure having a second curved slot and a second angled slot, wherein the second c-shaped bracket structure is coupled to the first c-shaped bracket structure such that the first angled slot is adjacent the second curved slot and the first curved slot is adjacent the second angled slot.

2. The device of claim 1, further comprising at least one vertical support post.

3. The device of claim 2 further comprising:
at least one stationary locking bracket coupled to a first vertical support post;
at least one moveable locking bracket coupled to the first vertical support post;
at least one stationary locking bracket coupled to a second vertical support post; and
at least one moveable locking bracket coupled to the second vertical support.

4. The device of claim 3, further comprising:
a partition panel having at least one upper stud pin and at least one lower stud pin on a first vertical side of the partition panel and at least one upper stud pin and at least one lower stud pin on a second vertical side of the partition panel,
wherein the at least one upper stud pin on the first vertical side of the partition panel is configured to couple to the at least one stationary locking bracket coupled to the first vertical support post,
the at least one lower stud pin on the first vertical side of the partition panel is configured to couple to the at least one moveable locking bracket coupled to the first vertical support post,
the at least one upper stud pin on the second vertical side of the partition panel is configured to couple to the at least one stationary locking bracket coupled to the second vertical support post, and
the at least one lower stud pin on the second vertical side of the partition panel is configured to couple to the at least one moveable locking bracket coupled to the second vertical support post.

5. The device of claim 2, wherein the at least one locking bracket comprises a cavity configured to mate to an outer perimeter of the at least one vertical support post.

6. The device of claim 1, wherein the first c-shaped bracket structure comprises at least one opening configured to couple to at least one end of the second c-shaped bracket structure.

7. The device of claim 2, wherein the second c-shaped bracket structure comprises a coupling feature configured to secure the at least one locking bracket to the at least one vertical support post.

8. The device of claim 1, wherein the first c-shaped bracket structure comprises a first portion adjacent a first corner, a second portion adjacent the first corner and a second corner, and a third portion adjacent the second corner,
and further wherein the second c-shaped bracket structure comprises a first portion adjacent a first corner, a second portion adjacent the first corner and a second corner, and a third portion adjacent the second corner,
wherein the first portion of the first c-shaped bracket structure is parallel to the first portion of the second c-shaped bracket structure and the third portion of the first c-shaped bracket structure is parallel to the third portion of the second c-shaped bracket structure.

9. A partition assembling system comprising:
at least two vertical support posts;
at least two locking brackets coupled to a first vertical support post of the
at least two vertical support posts;
at least two locking brackets coupled to a second vertical support post of the at least two vertical support posts; and
at least one partition panel comprising at least four attachment mechanisms, wherein the at least one partition panel is configured to couple to the at least two vertical support posts based on:
(1) coupling two of the at least four attachment mechanisms to the first vertical support post using the at least two locking brackets coupled to the first vertical support post, and
(2) coupling two of the at least four attachment mechanisms to the second vertical support post using the at least two locking brackets coupled to the second vertical support post.

10. The system of claim 9, wherein the at least two locking brackets on the first vertical support post comprises an upper locking bracket coupled to the first vertical support post in a stationary position and a lower locking bracket coupled to the first vertical support post in a moveable position,
and further wherein the at least two locking brackets on the second vertical support post comprises an upper locking bracket coupled to the second vertical support post in a stationary position and a lower locking bracket coupled to the second vertical support post in a moveable position.

11. The system of claim 9, wherein each locking bracket comprises:
a first c-shaped bracket structure having a first side, a second side, and a third side, wherein the first side comprises a first angled slot and the third side comprises a first curved slot; and
a second c-shaped bracket structure having a first side, a second side, and a third side, wherein the first side comprises a second curved slot, and further wherein the third side comprises a second angled slot.

12. The system of claim 9, wherein for each of the locking brackets, the first side of the first c-shaped bracket structure and the first side of the second c-shaped bracket structure are adjacent on a first face of the locking bracket, wherein the first side of the first c-shaped bracket structure is separated a threshold distance from the first side of the second c-shaped bracket structure.

13. The system of claim 12, wherein at least a portion of the separated threshold distance between the first side of the first c-shaped bracket structure and the first side of the second c-shaped bracket structure is configured to secure at least a portion of a stud pin on a first side portion of the at least one partition panel.

14. The system of claim 9, wherein for each of the locking brackets, the third side of the first c-shaped bracket structure and the third side of the second c-shaped bracket structure are adjacent on a third face of the locking bracket, wherein the third side of the first c-shaped bracket structure is separated a threshold distance from the third side of the second c-shaped bracket structure.

15. The system of claim 14, wherein at least a portion of the separated threshold distance between the third side of the first c-shaped bracket structure and the third side of the second c-shaped bracket structure is configured to secure at least a portion of a stud pin on a second side portion of the at least one partition panel.

16. The system of claim 10, wherein the upper locking bracket is oriented in an upward direction and the lower locking bracket is oriented in a downward direction.

17. A partition assembly mechanism comprising:
a pair of first locking brackets coupled to a pair of vertical support posts;
a pair of second locking brackets coupled to the pair of vertical support posts; and
a partition panel comprising a pair of upper stud pins on opposite vertical sides of an upper portion of the partition panel, and a pair of lower stud pins on opposite vertical sides of a lower portion of the partition panel, wherein each of the locking brackets comprises:
(1) a first c-shaped bracket structure comprising a first angled slot and a first curved slot, and
(2) a second c-shaped bracket structure comprising a second angled slot and a second curved slot.

18. The mechanism of claim 17, wherein the pair of first locking brackets is coupled to the pair of vertical support posts in a parallel, stationary position.

19. The mechanism of claim 18, wherein upon coupling the upper portion of the partition panel to the pair of first locking brackets via the pair of upper stud pins, the lower portion of the partition panel is pivotable in an outward direction from a vertical axis of the pair of vertical support posts.

20. The mechanism of claim 17, wherein the pair of second locking brackets are coupled to the pair of vertical support posts in a moveable position such that the pair of second locking brackets is configured to disengage from the lower stud pins on the lower portion of the partition panel in a first position, and engage the lower stud pins on the lower portion of the partition panel in a second position.
